(19) United States
(12) Patent Application Publication
(10) Pub. No.: US 2025/0346390 A1
(43) Pub. Date: Nov. 13, 2025

(54) Recyclable Shipping Pack and Method of and Apparatus for Forming a Shipping Pack for Loose-Fill Produce

(71) Applicant: Andrew David Whiteside, Bungay (GB)

(72) Inventor: Andrew David Whiteside, Bungay (GB)

(21) Appl. No.: 18/860,949

(22) PCT Filed: Apr. 28, 2023
(86) PCT No.: PCT/IB2023/054475

§ 371 Date: Oct. 28, 2024

Related U.S. Application Data
(63) Continuation-in-part of application No. 17/819,005, filed on Aug. 11, 2022, now abandoned.

(30) Foreign Application Priority Data
Apr. 28, 2022 (GB) 2206170.9

(51) Int. Cl. B65D 5/60; B31B 50/74; B31B 70/60; B31B 120/40; B65B 1/02; B65B 1/04; B65B 7/08; B65B 7/20; B65B 43/08; B65D 5/02; B65D 5/42; B65D 77/06

(52) U.S. Cl. CPC B65D 5/606; B31B 50/74; B31B 70/61; B65B 1/02; B65B 1/04; B65B 7/08; B65B 7/20; B65B 43/08; B65D 5/0227; B65D 5/4266; B65D 77/062; B31B 2120/402

(57) ABSTRACT

A container blank (1), so sized and shaped as to form a shipping pack having front (2) and rear (3) walls to which there are attached, along respective fold lines (2a, 2b, 3a), side wall sections (11, 12;16, 17) each being foldable so that said front and rear walls are in juxtaposed alignment, wherein an interior open-mouthed bag (30) is adhered to the inner surfaces of the front and rear walls. When a shipping pack is erected from said container blank, the folded interior bag (30) is deployed to align with the inner volume of said erected pack so as to provide an open-mouthed container with open-mouthed interior bag to be filled and subsequently sealed for dispatch. The shipping pack is configurable in a folded flat stackable form having an interior bag in situ for storage or dispatch and is easily machine assembled or manually formed into an open-mouthed shipping pack at point of use.

### FIELD OF THE INVENTION

The present invention relates to a container blank, a foldable shipping pack formed from a container blank within which there mounted a deployable interior bag and to a method of and apparatus for forming a shipping pack for use in packaging articles, particularly the packaging of multiple small items (including those individually wrapped) and most particularly for the packaging of loose-fill produce such as cereals, seeds, grain, dehydrated foodstuffs (including pet food), pet litter and the like.

The shipping pack formed from the container blank is adapted to be stored or shipped in bulk as folded packs for easy assembly at the point of filing and distribution. The invention also relates to a method of and apparatus for forming shipping packs from said container blanks and most particularly to the use of recycled, recyclable and compostable materials.

The invention particularly relates to a container blank made of card and cardboard or similar material, the blank being modified to include an interior bag therein to facilitate the packaging of loose-fill material and fixed volumes of small items within an easily assembled preformed folded shipping pack. Additionally, the invention relates to a system of manipulating the blank firstly to form a folded shipping pack and subsequently forming an open-mouthed pack for receipt of material before sealing said pack for dispatch (shipping) or storage. The invention is described hereinbelow with reference to loose-fill produce and multiple articles such as those exemplified above, however it should be appreciated that no such limitation exists.

It will be appreciated by the skilled addressee that the invention, although directed towards the packaging of loose-fill produce and of a plurality of smaller items (such as pre-packaged items of irregular shape, for example), may be applied to any three-dimensional object locatable within the container. The invention may also be used for the packaging and shipping of stacks of flat articles such as books and DVDs. Furthermore, the invention may with adaptation be applied to the storage, transportation and distribution of other produce including pastes, jams, nut-butters, jellies, moist foodstuffs (for example, meat-chunk dog or cat food) and fluids.

As noted above, the term “loose-fill” is not intended to be limiting, however, it is the ideal produce to which the primary objectives of the invention are directed. Examples of loose-fill produce include staple commercial products, such as seeds, grains, foodstuffs or detergents, and may range from powdered and granulated products; including instant coffee, sugar, washing machine powder and cornflour; flaked goods, such as cereals and dried dog food; and multiple loose unwrapped items, such as biscuits (including dog biscuits) and wrapped items such a chocolate confectionary.

The term “container blank” is directed to a cut, preformed profile of unitary stock material to which adhesive and additional material having identical or substantially similar recycling characteristics to the stock material from which the blank is formed is adhered or otherwise attached.

The invention additionally relates particularly to a method of and apparatus for forming folded shipping packs and to a system of erecting, filling and sealing shipping packs, the packs ideally being machine-formable on an automated line in a distribution centre or warehouse.

### BACKGROUND TO THE INVENTION

Increasingly, customers are eschewing the time-consuming routine of travelling to purchase their shopping and/or personal and business requisites. It is now common for purchases to be made by mail order, telephone and via the Internet and email. As a consequence, for goods to be received there is a marked increase in the use of postal and courier services to deliver the purchases.

With the increased popularity of Internet shopping and the dispatch of ordered articles via the postal system the requirement for packaging has increased manyfold. The popularity of such websites as Amazon™ and eBay™ have increased the postal traffic of books, CDs, CDROMs and DVDs amongst others. As the above markets and public familiarity with online shopping developed, so too has the rapidity with which deliveries are made and the acceptability of dispatching staple products, daily ‘consumables’ (industrial, commercial and domestic commodities), foodstuffs and other perishables. In the domestic environment, this has increased the bulk buying of certain materials that would often be bought in branded packaging at retail outlets such as supermarkets.

One of the perceived disadvantages of bulk buying produce is that plastic packaging is often used to wrap individual items or weighted portions which are then loose-filled within RSC (Regular Slotted Carton) style packs with integrated plastic shrink-wrap liners to prevent movement of the packet contents. Notably, such liners do not prevent ingress of moisture or egress of odours. Consequently, contents are often placed in plastic bags or flow-wrapping techniques are utilised to form ‘pillows’ of sealed produce.

Containers formed from blanks made of card and cardboard and other materials suitable for dispatch through the postal services are well known in the prior art. Generally, the containers are formed from a relatively simple blank having multiple cut-aways to define a blank having side walls separated by fold lines and one or more base and lid portions connected to one or more of the side walls by corresponding fold lines. Commonly, to construct the container, an end tab of one side wall is secured to an edge portion of another side wall and the or each base portion is folded and secured to form an open-mouthed container. When the or each article to be dispatched has been placed within the container, the or each lid portion is folded and secured. The means of securing the portions to form the container is normally selected from gluing, stapling or applying adhesive tape.

It will be appreciated that unless the container is designed to receive the specific article(s) to be dispatched, further packaging materials will be required to prevent the article(s) moving about within the container. In the packaging industry generally, there is a move to obviate extraneous packaging materials and in some countries there are regulations and legislation to prevent wasteful packaging practices.

In an attempt to obviate some of the disadvantages highlighted above, a solution suggested in the prior art is to utilise a web of lining material to encapsulate or secure the articles within the container to prevent damage due to movement within the container during transit to its destination.

French Patent Application Publication No. FR 2 853 885 to SMURFIT SOCAR S.A., discloses a preformed cardboard box having a pair of paper sheets attached to opposing inner side walls and adapted to overlie and to be secured to one another, thereby aligning double faced adhesive bands, so as to hold objects in position within the box. This obviates the step of heating a sheet of heat shrink plastics material and provides an essentially recyclable shipping pack.

United Kingdom Patent Application Publication No. GB 832,372 to HENSING and KOHRIG discloses a pack of the folded carton type having a foil, paper or plastics material lining formed as a tube within an open-mouth and open-base container, so as to facilitate the concurrent closing and sealing of the liner and container at each of the base and top of the container. The primary object of the invention is to obviate the necessity for separately closing the lining and the carton and highlights the difficulties to be avoided where the lining is secured to the closing flaps of the carton. It is a particular feature of the invention to provide a fastening triangle in the form of an isosceles triangle, the securing triangles being fastened by adhesive tape of the like to the opposite side walls of the carton.

U.S. Pat. No. 9,340,317 to SMART KARTON WORLDWIDE LLC discloses a container blank of the RSC type to which a material web is attached to retain an article within the container formed from the lined blank. The material web is recyclable and coated with a cohesive film so that tension can be applied to one or more articles within the container by overlying cohesive portions and tensioning the web against the articles.

In each disclosure of the exemplifying prior art, a container blank is provided with a material web liner which is attached to a plurality of container blank panels. As the blank is erected, the liner is folded in a manner dictated by attachment points or glue lines. None of the disclosures feature a sealed liner or a liner having a pre-formed base region seal opposite an open mouth presented for filing prior to sealing.

As noted above, prior art liners do not prevent ingress of moisture or egress of odours and it is the presence of odours that increasingly attracts rodents and insects presenting further disadvantages neither appreciated nor addressed in the exemplifying art. It is known that sealable bags and inflatable bladders, often comprising metalized polyethylene terephthalate (PET) foils, are used in combination with card and paperboard cartons, including for non-carbonated beverages such as fruit juices and wine. One disadvantage of such bladder or pouch-within-box arrangements is that there is often a notable volume of the primary container left unused.

There has been an increasing awareness for the need for packaging to be easily recyclable and, although the general public are increasingly involved in the separation of recyclable and non-recyclable waste, where there is separation of materials required it is perceived as being simpler simply to discard the entire packaging for processing as non-recyclable waste. More recently, packaging legislation has pushed packaging manufacturers towards simpler and less obtrusive packaging use to cut down the volume of packaging material that is used for individual containers.

One specific utilisation of the invention relates to the packaging and storing of animal feeds, particularly dried dog food. Traditional packaging comprises a cardboard container (occasionally incorporating a spout or tear-strip with foldable lid) within which no liner or interior bag is provided. Glue lines are used in the formation and sealing of the container, however, no tape sealing is provided at any exposed carboard material edge or at the package ends.

At the request of the Applicant, trials were conducted at the Centre for Grain and Animal Health Research in the Agricultural Research Service (ARS) of the United States Department of Agriculture (USDA) to compare packaging integrity for commonly available dried dog food produce within an industry accepted package with packaging exemplifying of the present invention. Details of the trials are provided in the detailed description hereinbelow.

It is an object of the present invention to alleviate the above disadvantages and to provide a shipping pack that is wholly recyclable and has a retaining means therein which is deployable to utilise substantially all of the pack volume.

It is an object also of the present invention to provide a shipping pack comprising a container blank and interior bag each constituted wholly of recycled, recyclable or compostable materials.

It is additionally an object of the present invention to provide a shipping pack for foodstuffs and like produce, known to attract insects and rodents when left in storage, which has attenuated risk of attracting rodents or suffering insect infestation.

It is also an object of the present invention to provide a method of and apparatus for forming a folded shipping pack stackable for dispatch or storage.

It is a further object of the present invention to provide a shipping pack having an interior bag deployable into an open-mouther configuration from a folded configuration.

It is a yet further object of the present invention to provide a system of erecting, filling and sealing an open-mouthed shipping pack.

### SUMMARY OF THE INVENTION

In its first aspect, the present invention provides a container blank, so sized and shaped as to form a folded erectable shipping pack, the blank having front and rear walls to which there are attached, along respective fold lines, side wall sections each being foldable so that said front and rear walls are held in juxtaposed alignment when the blank is in a folded or storage configuration, the front and rear walls being adapted to secure therebetween corresponding rear and front walls of a folded interior bag having a sealed base and sealable open mouth,
so that when the container blank is erected from said folded configuration, the interior bag is deployed to an open-mouthed configuration in which the bag assumes substantially the inner volume of the shipping pack thus formed.

In its exemplifying embodiment, the blank has a first primary fold line, about which a selected one of the front and rear walls of the blank is folded to align with the other of said walls, to which one face of the interior bag is adhered, the folded blank wall being brought into alignment with and adhered to the exposed face of the interior bag; and a second primary fold line, about which a side wall section is folded to align with an end closing tab which is adhered thereto, to form the folded shipping pack within which said interior bag is secured by its rear and front faces to the inner surfaces of the front and rear walls respectively of the container blank.

It will be seen by the skilled addressee that the bag may be adhered to the interior surface of the front wall and the rear wall is subsequently folded around the first primary fold line or visa versa to align and adhere to the exposed face of the interior bag.

The container blank is provided as a pre-cut profile having fold lines integrated into the profile to ensure rapid and accurate folding during either manual or mechanical folding. The primary fold lines utilised to form the folded shipping pack provide, in a manner well-established in the art, sufficient rigidity to prevent the profile collapsing under its own weight while facilitating a clean inward folding action as required.

The blanks are ideally provided as a magazine stack for machine-feeding to an apparatus for forming folded shipping packs. Cold seal, pressure activated adhesive may be applied to the outer surface of the end closing tab and/or the inner surface of the free side wall element so as to eliminate a glue application step in the forming of said folded shipping packs. It will be appreciated by the skilled addressee that a cohesive adhesive will ensure minimal snagging between blanks and a more secure bond between said end closing tab and side wall element.

In an erected, open-mouthed configuration, base-forming elements of the blank are folded around their respective fold lines to abut and support the sealed base of the interior bag, so that the pack may be filled with produce for shipping and storage.

In a second aspect, the present invention provides a shipping pack comprising:
a container blank, so sized and shaped as to form a folded shipping pack, the blank having front and rear walls to which there are attached, along respective fold lines, side wall sections each being foldable so that said front and rear walls are in held juxtaposed alignment to define a folded configuration; and
a foldable open-mouthed bag having front and rear faces which are adhered between the front and rear walls of the blank,
wherein, as the container blank is erectable from said folded configuration, the folded interior bag is deployed to align with the inner volume of said erected blank so as to provide an open-mouthed shipping pack having an open-mouthed interior bag to be filled and subsequently sealed for dispatch.

The shipping pack of the invention comprises the preformed container blank profile and an interior bag provided in a folded configuration.

Conveniently, the interior bag is provided in a folded configuration where the side walls and base thereof are folded along respective centrally disposed longitudinal fold lines so as to present only the rear and front faces as major surfaces to be adhered to the inner surfaces of the front and rear walls respectively of the container blank.

It will be appreciated that alternative folded configurations of the bag may be used without departing from the spirit of the invention and that the side walls of the bag may fold outwardly and can include regions or spots where they can be adhered to the inner surfaces of the side walls of the blank in the folded shipping pack configuration. It is the inward folding of the base of the interior bag along a longitudinal and ideally central fold line that provides the enhanced utility to the interior bag.

Preferably, a coating is applied to at least the inner surface of the interior bag. Resistance to the permeance of moisture and/or odours provides added benefit to the shipping pack whether in preventing produce being spoilt in transit or to prevent odour carrying components from transferring from one shipped product to another. The egress of volatile oils from certain produce may result in a significant reduction in its value and the potential contamination of others.

In an enhanced construction, additional fold lines are formed around the open mouth of the interior bag so as in one arrangement to direct a user to form manually a sealable closed-mouth configuration or so as in a further arrangement to facilitate the machine folding and/or closing of a filled interior bag.

In a further construction, the interior bag has cohesive portions to which adhesive is applied adjacent the open mouth thereof, the portions being brought together manually or by machine folding and/or closing so that pressure may be applied to activate adhesive bonds to seal the bag.

Optionally, the cohesive portions are spray coated with a cold-seal adhesive.

Alternatively, the open mouth of the interior bag is sealed using water activated adhesive tape.

In a preferred construction, the shipping pack comprises:
a container blank having a series of six segments, each defining a wall section to which there is attached, along respective fold lines, a base element and a lid element, the segments being joined to at least one other segment by a side wall fold line; and
an interior bag, having wall segments corresponding to each of those of the blank, to which there is attached, along respective fold lines, a base element which in a storage or transport configuration is folded along a central longitudinal fold line and in its erected configuration forms a flat base region perpendicular to each of the bag segments;
wherein the interior bag, in its erected configuration is deployed to conform to the interior volume of the erected container blank to form an open-mouthed shipping pack for receipt of articles or produce to be sealed therein for dispatch.

Conveniently, the interior bag is so sized and shaped as to fit within the peripheral profile of the container blank, thereby minimising snagging and facilitating increased throughput. Additionally, edge-damage to the bag during storage or transportation is minimised during storage or transportation.

Although the shipping pack may be conveyed, stored or dispatched in an open configuration, it is ideally folded so that the interior bag is not potentially exposed to snagging or tearing prior to being folded into the storage or transport configuration where the bag is fully protected by the blank. As noted above, by folding the container blank about the first primary fold line, the interior bag is protected. Sealing the blank around the bag by adhering the end closing tab to the free side wall element to form a flat stackable shipping pack provides enhanced protection and utility. Thereafter, when the shipping pack is required for its intended purpose, manual or machine-applied pressure to the peripherally disposed primary fold lines causes the pack to assume a substantially tubular configuration where the bag deploys within the tube. The base sections of the blank are then folded to support the base of the bag and the shipping pack assumes its open-mouthed configuration.

In a third aspect of the invention, there is provided a method of forming a shipping pack from a container blank of the type having front and rear walls to which there is attached a deployable interior open-mouthed bag adapted to deploy from a folded configuration to align with and conform to the inner volume of an erected pack formed from said blank, the method comprising:
forming a folded shipping pack by adhering a major face of a folded bag onto the interior surface of one of said front and rear walls of the container blank and folding, into alignment with the adhered bag and selected wall, the other of said front and rear walls around a primary fold line therebetween; and
folding a free wall edge of the container blank around a second primary fold line and adhering an end closing tab thereto so as to secure the shipping pack in a storage or transport configuration with said bag secured therein.

The method further comprises:
erecting the folded shipping pack into an open-mouthed configuration by applying side wall pressure thereby deploying the interior bag into a corresponding open-mouthed configuration;
bringing together and securing base sections of front and rear walls and base elements of said side walls to form a shipping pack base adjacent and supporting the base of the interior bag;
placing one or more articles or produce into the open-mouthed bag within the erected shipping pack;
closing the open mouth of the interior bag;
bringing together and securing lid sections of front and rear walls and lid elements of said side walls to form a shipping pack lid over the sealed mouth of the interior bag;
sealing the lid; and
conveying the closed shipping pack for dispatch or storage.

Advantageously, additional fold lines formed around the open mouth of the interior bag to facilitate the manual closing or machine folding of a sealable closed-mouth configuration.

Advantageously, the step of closing the open mouth of the interior bag includes bringing together cohesive portions disposed about the open mouth thereof to which adhesive has been applied whereby the adhesive bonds together to seal the bag.

Optionally, the open mouth of the interior bag is closed and the lid sections are secured using water activated adhesive tape.

In a further aspect of the invention, there is provided an apparatus for forming a shipping pack from a container blank of the type having attached therein a deployable interior open-mouthed bag adapted to deploy from a folded configuration to align with and conform to the inner volume of an erected pack formed from said blank, the apparatus comprising:
a magazine from which a container blank is fed;
an adhesive application station;
a magazine from which a folded bag is fed onto a selected inner face of a first major surface of the container blank;
a conveyor means;
a folding station where the blank is folded around a primary fold line to bring the inner surface of a second major surface into alignment with said first surface between which the folded bag is disposed and to bring an end closing tab adjacent a second primary fold line;
a folding means adapted to fold a free side wall element around said second primary fold line to overlie the closing tab; and
a forming station where pressure is applied to the major faces and the side wall element to ensure adequate adhesion to retain the folded shipping pack thus formed in its storage or transport configuration.

It will be appreciated that the interior bag may be adhered initially to either one of the major surfaces (the front and rear walls) before folding is performed around the first primary fold line.

The first apparatus of the invention implements the method of forming a folded shipping pack from a container blank and interior bag which may then be conveyed individually to a further erecting, filling and sealing apparatus or stacked for storage or for transportation to a sales outlet or distribution facility.

The present invention yet further provides an apparatus for erecting, filling and sealing an open-mouthed shipping pack formed from a folded shipping pack as herein defined of the type having an interior folded open-mouthed bag, the apparatus including:
means for erecting the folded shipping packed into an open-mouthed configuration by applying side wall pressure thereby deploying the interior bag into a corresponding open-mouthed configuration;
means for bringing together and securing base sections of front and rear walls and base elements of said side walls to form a shipping pack base adjacent and supporting the base of the interior bag;
a filling station having means for placing one or more articles or for pouring produce into the open-mouthed bag within the erected shipping pack;
means for closing the open mouth of the interior bag;
means for bringing together and securing lid sections of front and rear walls and lid elements of said side walls to form a shipping pack lid over the sealed mouth of the interior bag;
sealing means for closing the lid; and
conveyor means for conveying the closed shipping pack for dispatch or storage.

Although it will be appreciated that the folded shipping pack of the invention may be manually erected, filled and/or sealed, it is also applicable to rapid automation by machine implementation.

Upon filling, means may be employed to utilise additional fold lines formed around the open mouth of the interior bag to form a sealable closed-mouth configuration.

In one arrangement the interior bag has cohesive portions to which adhesive has been applied adjacent the open mouth thereof, the apparatus including means for bringing the portions together under applied pressure so that the adhesive bonds to seal the bag.

Optionally, the apparatus includes a dispenser for applying water activated adhesive tape to the open mouth of the interior bag and to the lid sections.

Handle apertures are optionally provided in the front and rear walls, however, it has been noted that high density produce within the interior bag may make grip difficult or uncomfortable for a user. The same experience is noted where aligning handle apertures are provided in the lid sections. An alternative is to adhere a card material handle which may be pulled through the aligning handle apertures.

A further modification to the shipping pack includes the formation of a tear strip within the blank corresponding to the upper periphery of an erected shipping pack adjacent the lid sections. This facilitates the rapid exposure of the folded and/or sealed interior bag for the convenience of the end user.

### BRIEF DESCRIPTION OF THE DRAWINGS

The invention will now be described more particularly with reference to the accompanying drawings which show, by way of example only, one embodiment of shipping pack comprising a container blank and interior bag. Reference is also made to methods of and apparatus for forming a shipping pack from a container blank and to a method of and apparatus for erecting, filling and sealing a shipping pack in accordance with the invention. In the drawings:

FIG. 1 is a schematic perspective elevation of a container blank onto which a first set of glue lines are applied;

FIGS. 2a to 2c are perspective views of an interior bag in deployed configurations and in a folded configuration, respectively;

FIG. 3 is a schematic perspective elevation of the container blank of FIG. 1 onto which a folded bag of FIG. 2c has been adhered to the inner surface of a rear wall of the blank utilising the applied glue lines;

FIG. 4 is a perspective view of a folding step where the front face inner surface is folded around a first primary fold line to be adhered to the exposed face of the folded interior bag utilising the glue lines applied to said front face inner surface;

FIG. 5 is a perspective view of a folded shipping pack where a free side wall element has been folded over the second primary fold line to adhere to an end closing tab;

FIG. 6 is a perspective elevation of an open-mouthed shipping pack formed from the folded shipping pack of FIG. 6 for receipt of items or loose-fill produce for subsequent sealing and storage or dispatch;

FIG. 7 is a schematic perspective representation of a production line for the forming of a shipping pack from a container blank and a deployable interior open-mouthed bag in which stations (vii) to (xiv) are illustrated in FIGS. 8 to 14, respectively;

FIG. 8 is a schematic perspective representation of a first station (viii) comprising a magazine into which container blanks are loaded and from which they are fed via a second station (ix);

FIG. 8 is a schematic perspective representation of a first station (viii) comprising a magazine into which container blanks are loaded and from which they are fed via a second station (ix);

FIG. 9 is a schematic perspective representation of a second station (ix) comprising a gate and a feed roller mechanism to present the container blank to a third station (x);

FIG. 10 is a schematic perspective representation of a third station (x) comprising a glue application station where glue lines are applied to the container blank before an interior bag is adhered to an interior surface thereof at a fourth station (xi);

FIG. 11 is a schematic perspective representation of a fourth station (xi) comprising an interior bag placement station where a single interior bag is fed from a magazine onto a selected inner surface of the blank;

FIG. 12 is a schematic perspective representation of a fifth station (xii) where pressure is applied to the exposed surface of the interior bag to ensure the adherence of the adhesive disposed between the interior surface of the blank and the interior bag thereon;

FIG. 13 is a schematic perspective representation of a sixth station (xiii) where the container blank is folded around a first primary fold line P1 to align a free interior surface of the container blank with the exposed face of the interior bag and adhere thereto, whereafter the free edge of the blank is folded around a second primary fold line P2 and secured to an end closing tab; and

FIG. 14 is a schematic perspective representation of a seventh station (xiv) clear individual folder shipping packs are stacked for subsequent use in a magazine or bundled for storage or transportation.

### DETAILED DESCRIPTION OF THE PREFERRED EMBODIMENT

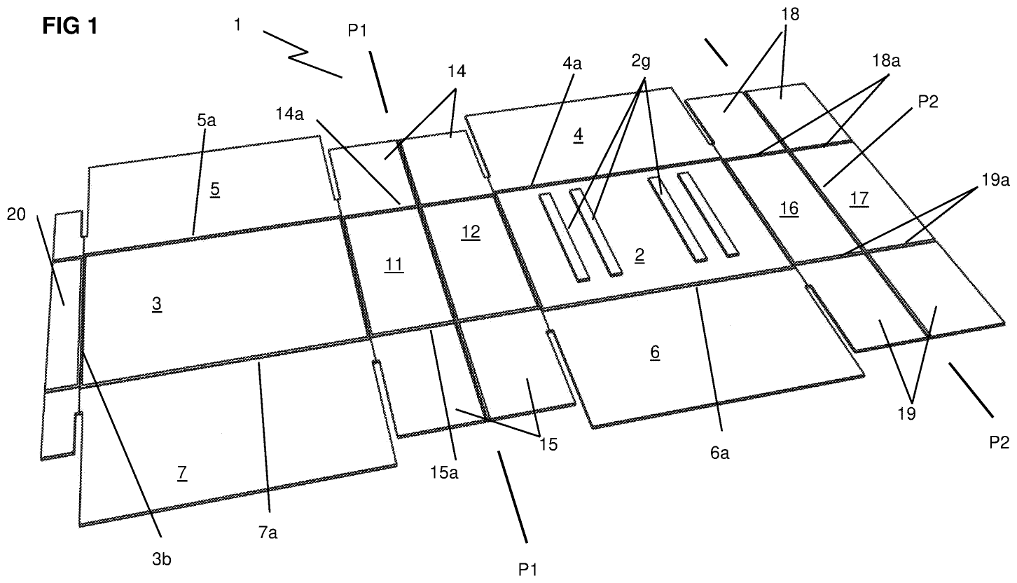

Referring to the drawings and initially to FIG. 1, there is provided a container blank 1 cut from kraft card, cardboard or another recycled or recyclable and ideally composable material and is preferably die-cut corrugated board.

The blank comprises first and second wall sections defining the major surfaces identified hereafter as rear wall 2 and front wall 3, respectively. Each wall section has a lid forming section 4, 5 attached thereto along respective fold lines 4a, 5a. Each wall section also has a base forming section 6, 7 attached thereto along respective fold lines 6a, 7a disposed oppositely said lid sections 4, 5.

Disposed between said front and rear walls 2, 3 is a first side wall section comprising a pair of side elements 11, 12 each having identical lid elements 14 and base elements 15 attached thereto along respective fold lines 14a, 15a. The side wall section elements 11, 12 are connected to one another along a first primary fold line P1 which also defines a fold line between each of said lid elements 14 and base elements 15. Minor folds lines 2a, 3a connect said first side wall section to the rear wall section 2 and the front wall section 3, respectively.

Connected to the opposite side of the rear wall 2 along a minor fold line 2b is a second side wall section comprising a pair of side elements 16, 17, each again having corresponding lid elements 18 and base elements 19. The lid and base elements 18, 19 are attached to the side elements 16, 17 along respective fold lines 18a, 19a. As before, the side wall section elements 16, 17 are connected to one another along a second primary fold line P2 defining also a fold line between each of the lid elements 18 and each of the base elements 19.

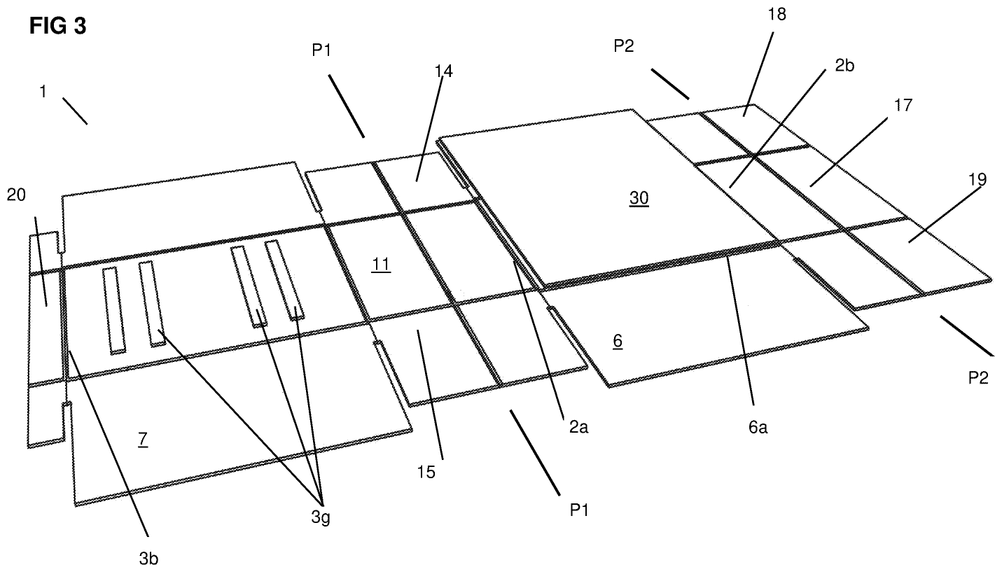

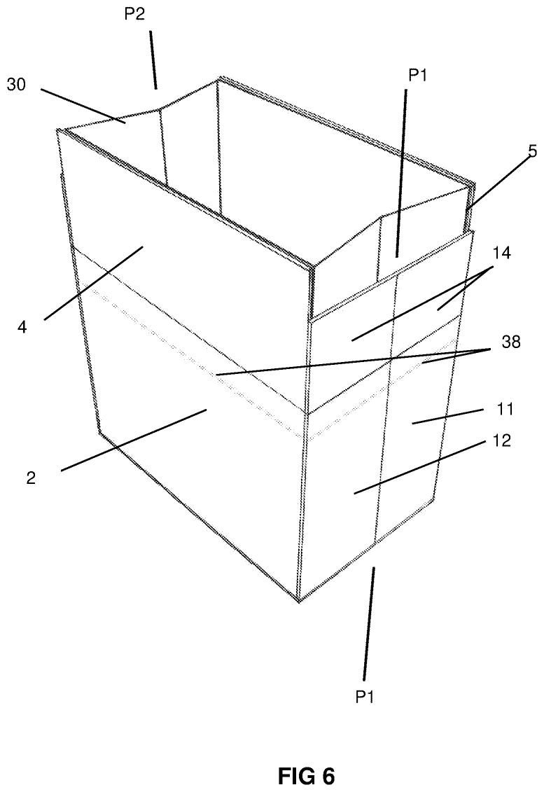

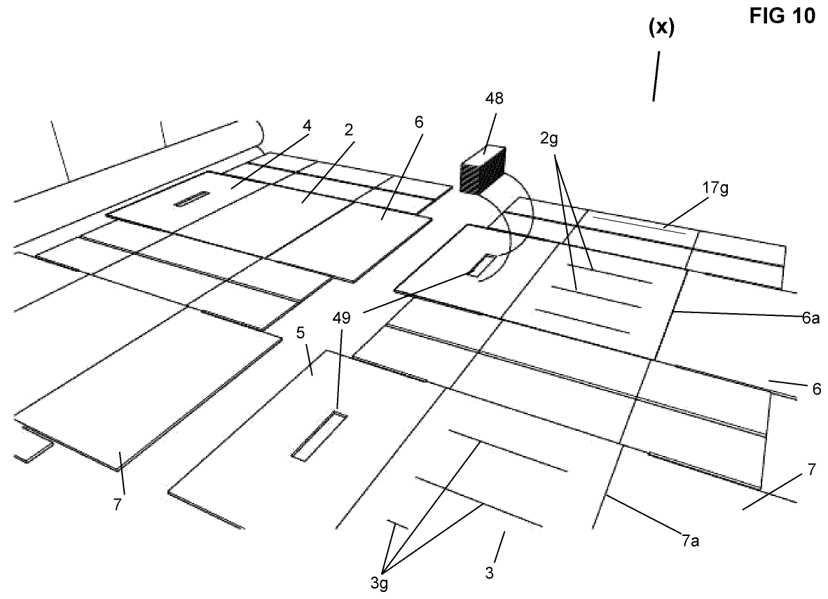

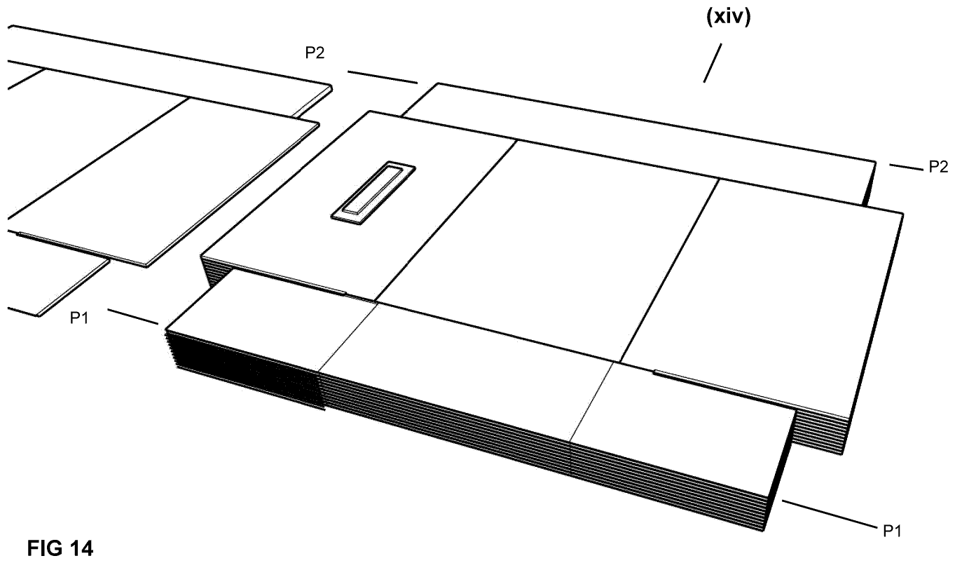

Connected to the free side of the front wall 3 along a minor fold line 3b is an end closing tab 20 adapted to engage the free side wall element 17 and be fixed thereto to form a folded shipping pack of the invention for storage or transportation to a distribution hub, as illustrated in FIG. 14, or alternatively to be fashioned into an open-mouthed shipping pack, as illustrated in FIG. 6, for filling, sealing and dispatch. A series of glue lines 2g are applied to the inner surface of the rear wall 2 (or alternatively glue lines 3g are applied to the inner surface of the front wall 3) and will be referred to again with respect to FIG. 3 and FIG. 10.

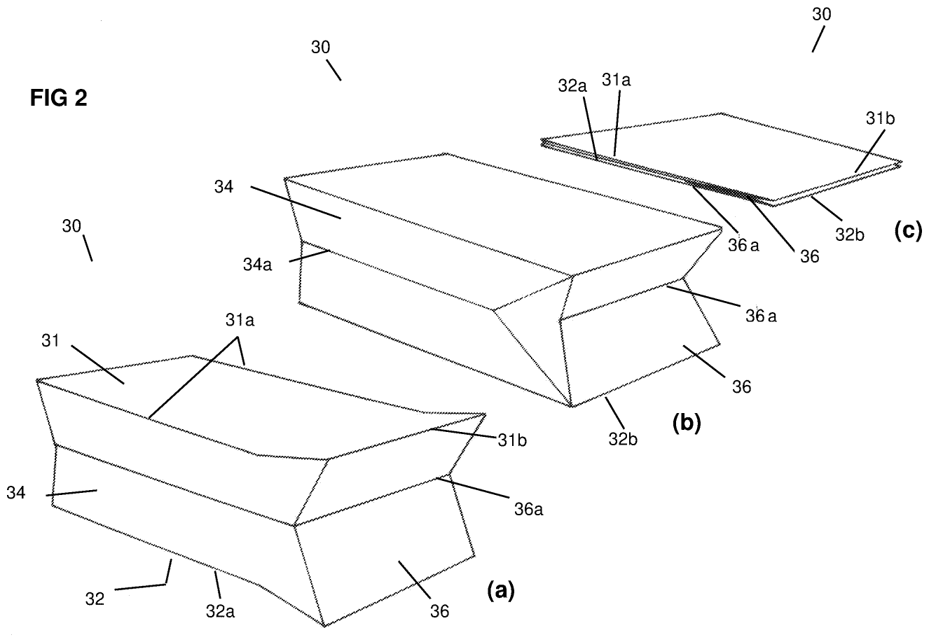

As illustrated in FIGS. 2a to 2c, a flexible and foldable bag 30 has a deployed configuration and a folded configuration where its side walls and base are concealed. Ideally, the bag 30 comprises a standard light kraft paper having flat front and rear faces 31, 32 connected to side walls 34 along respective fold lines 31a, 32a and to a base 36 along respective fold lines 31b, 32b. Each of the side walls 34 has a centrally disposed longitudinal fold line 34a. The base 36 also includes a longitudinal fold line 36a allowing both the base and each of the side walls 34 to fold into the geometry defined by the front and rear faces 31, 32. Thus, when folded, the fold lines 31b, 32b between said faces 31, 32 and the base 36 define the lower peripheral edge of the folded bag 30.

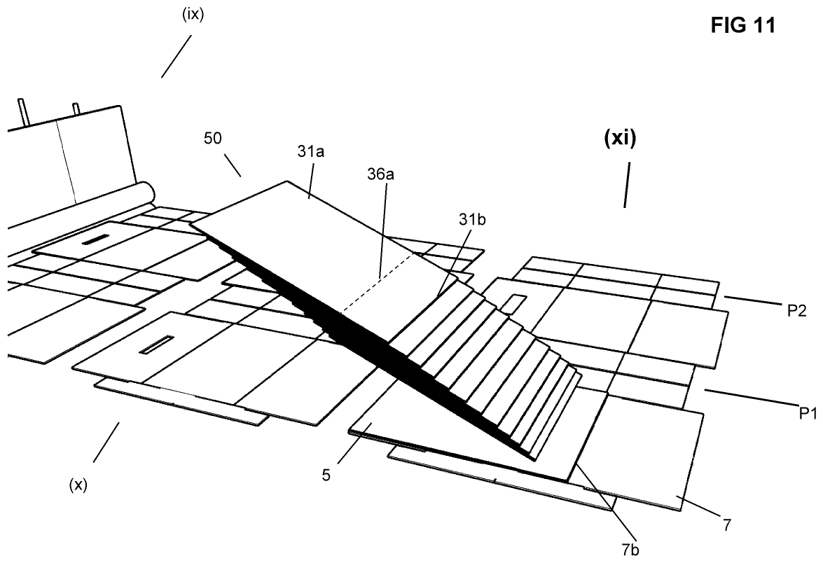

The bag 30 is supplied in a folded configuration so that it may be magazine-fed, as will be described in more detail hereinbelow, with particular reference to FIG. 11.

Ideally, the bag is formed from a unitary sheet of material which may be coated on one surface to provide moisture-resistant and odour impermeable characteristics. Different substrates may be applied to either side of the material forming the bag, however, it is preferred that the recyclability of the bag is unimpaired. As noted above, the focus of the invention is directed to dry loose-fill materials, however, it will be appreciated that with appropriate coatings and sealing of the interior bag, other produce from pastes, jams, nut-butters, jellies, moist foodstuffs (for example, meat-chunk dog or cat food) and fluids can be packaged and stored in the shipping pack of the invention. This can be particularly advantageous for foodstuffs and materials that need to be dispensed from a relatively wide bore feed as the open-mouthed profile of the interior bag can accommodate most requirements.

It will also be appreciated that although the focus of the invention is primarily directed to fully recyclable products and that it is preferred that no separation of exterior box and interior bag should be required, it is not entirely essential and that there are fully waterproof interior bag materials available that are recyclable in their own right.

Referring now to FIG. 3, the folded bag 30 is positioned on the inner surface of the rear wall 2 and held thereto by the glue lines 2g. As noted above, the fold lines 31b, 32b adjacent the base 36 define the lower peripheral edge of the bag 30 and are aligned with the base section fold line 6a at the lower edge of the rear wall 2 of the container blank 1. Additional glue lines 3g on the front wall 3 may be applied concurrently with those on the rear wall 2 or as part of a separate method step.

Although glue lines 2g are illustrated on the inner side of the rear wall 2, the bag 30 may be secured by applying glue to the bag 30 as it is fed into position with respect to the blank. In either case, pressure is applied equally across the engaging surface of the bag (that is, the surface thereof covering the inner surface of the rear wall 2). Again, the glue lines 3g illustrated on the inner surface of the front wall 3 may be obviated by spray application of adhesive to the major engaging surface 31 of the bag. Many adhesives require pressure to activate, however, certain spray contact adhesives will achieve the desired objectives provided the glue lines are accurately applied.

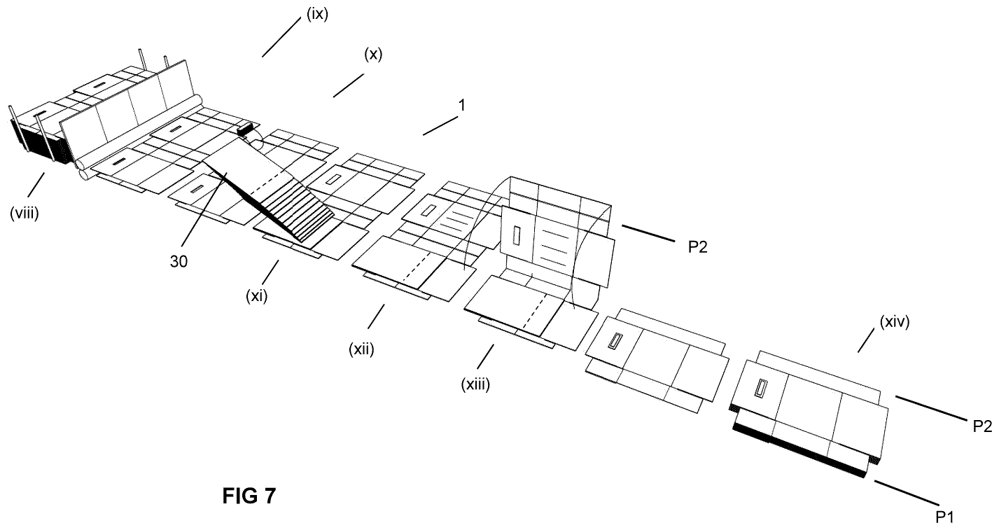

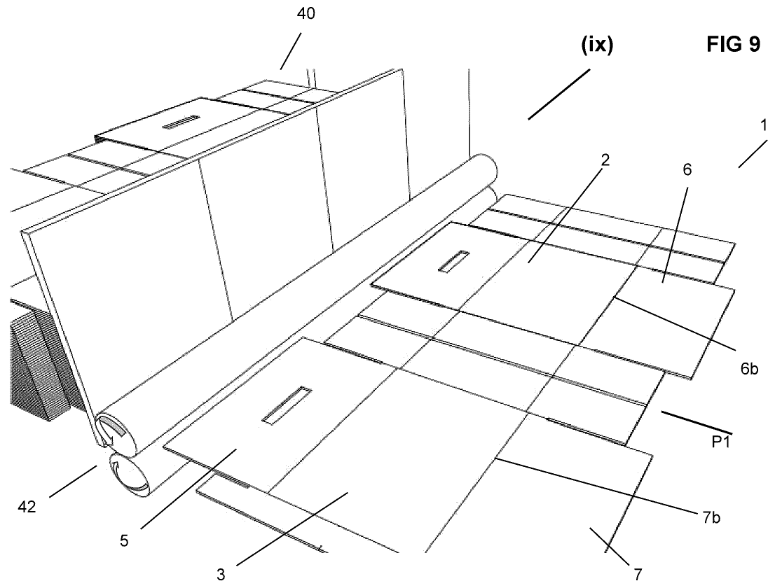

Although the exemplifying arrangement of FIGS. 3 to 5 illustrates the placement of the interior bag 30 on the rear wall 2, an alternative where the interior bag 30 is adhered to the front wall 3 via glue lines 3g is perfectly feasible and is illustrated in the exemplifying shipping pack forming method shown with reference to FIGS. 7 to 14.

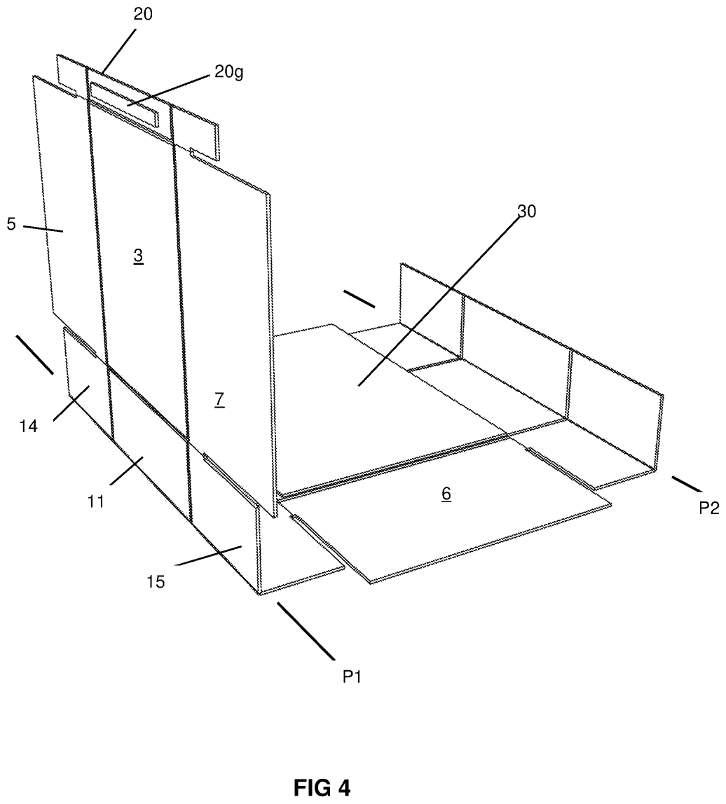

FIG. 4 illustrates a method of forming a folded shipping pack from the blank 1 and interior bag 30. With the bag 30 secured to the inner wall 2, the front wall 3 is folded over the first primary fold line P1 (defined between the first side wall elements 11, 12) to bring the inner surface of the front wall into alignment with the rear wall 2 with the bag 30 held therebetween. The free end wall element 17 (together with its lid and base elements 18, 19) is folded over the second primary fold line P2 so that the end closing tab 20 is engaged thereby and secured thereto by the glue line 20g on the outer surface of said tab 20.

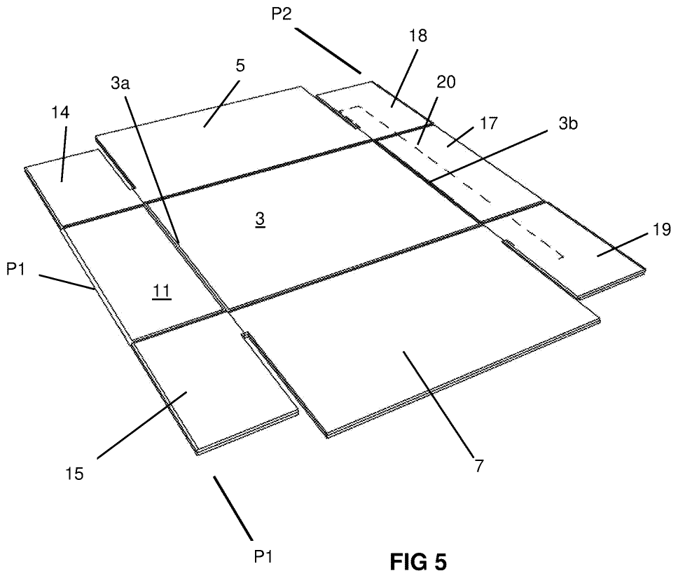

The folded shipping pack with integral bag is illustrated in FIG. 5. The folded pack may be stacked within a magazine for immediate subsequent use or bundled for storage or transportation.

To assemble the shipping pack of the invention, an open-mouthed container, as shown in FIG. 6, is formed (either manually or mechanically) by erecting a folded shipping pack by applying inward pressure to each of the primary fold lines P1, P2 at or adjacent the side wall elements. As the interior bag 30 is adhered to the respective inner surfaces of the front wall 3 and rear wall 2 of the container blank, the bag 30 deploys from its folded configuration as the front and rear walls are moved apart by the unfolding of the side wall sections 11,12; 18,19.

A further modification to the shipping pack includes the formation of a tear strip 38 within the blank corresponding to the upper periphery of an erected shipping pack adjacent the lid sections, as illustrated in FIG. 6. This facilitates the rapid exposure of the folded and/or sealed interior bag for the convenience of the end user.

It will be appreciated by the skilled addressee that the use of a pre-formed folded interior bag of kraft card or paper provides a major advantage of the present invention, in that the shipping pack is entirely recyclable rather than extra costs being incurred in packaging levies and recycling costs which is now predominant with packaging using multiple material types or materials which cannot be recycled at the same time or same process.

As referenced in the preamble, the shipping pack of the invention finds particular utility in the shipping of foodstuffs in the 3 kg to 30 kg range. The open-mouthed presentation of the interior bag is advantageous in the transfer of loose-fill produce from large hooper-fed storage onto a container filling line. Exemplifying of this utility is in the provision of boxed animal and pet feeds, of which dried dog food is the most familiar.

Unfortunately, traditional boxed solutions do not provide sufficient protection against damage from moisture, infestation from insects or attack by rodents.

In an attempt to assess the vulnerability of packaging from insect infestation, USDA-ARS trials, conducted at the Centre for Grain and Animal Health Research, were formulated to assess packaging integrity against a number of different insects known to infest stored products.

The insects selected were from colonies maintained at the USDA-ARS facility and included:
Tribolium castaneum, red flour beetle (RFB) 1-to-2-week-old adults.
Oryzaephilus surinamensis, sawtoothed grain beetle (STGB) 1-to-2-week-old adults.
Plodia interpunctella, Indian meal moth (IMM) 3^{rd} instars (11 days from egg introduction).
Trogoderma variabile, warehouse beetle (WB) Small/medium larvae

Testing bins with waterproof and dustproof lids were provided with a series of airholes covered with fine mesh and a small finite food supply to prevent starvation but insufficient to sustain development. One hundred each of red flour beetle adults and sawtoothed grain beetle adults and fifty each of warehouse beetle larvae and Indian meal moth larvae were added to the bins to compare traditional box containers (control) with the box containers of the invention (trial).

Observations followed two weeks in an environmental chamber and a subsequent week in a freezer. Each box was examined for the number of insects outside of the box and inside the box (and interior bag in the trial box). Observations for the trial box were further broken down into the number of insects in the tape, between the box and bag and inside the bag. The contents of the control and trial boxes were sieved to find any insects inside the box.

The observations are briefly summarised as follows:

Control (traditional) packaging did not prevent any infestation of the insect species and numerous larvae, pupae and adults were found within the box (and therefore within the food contents).

Trial packaging faired exceptionally well with significantly lower numbers of larvae, pupae and adults found between the box and interior bag primarily due to superior tape sealing of the base and exposed board edges. Tape adhesive also acted as a barrier. Of the insects found to have reached the top of the interior bag, all were prevented from accessing the food contents by the sealing of the interior bag.

The essential conclusion of the trials is that traditional box only packaging even with tape sealing is insufficient to prevent infestation of the contents whereas with complete sealing of an interior bag within a properly taped box, far superior protection again infestation is afforded.

The invention further provides a method of and an apparatus for forming a shipping pack from a container blank. It will be appreciated by those familiar with packaging machinery that there are numerous ways to effect the method of forming a shipping pack from a profiled blank and that the exemplifying method and apparatus described hereinbelow is one of a number of variants, dependant on particular size and throughput requirements.

Although not illustrated in detail, the apparatus as schematically illustrated in FIG. 7 effectively comprises:
a conveyor means;
a magazine from which a pre-profiled container blank 1 is fed onto said conveyor means to present inner faces of a front and rear wall thereof;
an adhesive application station;
a magazine from which a folded bag 30 is fed onto the inner face of a selected one of the front and rear walls of the container blank 1;
a folding station where the blank is folded around a primary fold line P1 to bring the inner surface of the remaining wall into alignment with the selected wall between which the folded bag 30 is disposed and to bring the second primary fold line P2 adjacent the end closing tab 20;
a folding means adapted to fold a free side wall element 17 around said second primary fold line P2 to overlie the closing tab 20; and
a forming station where pressure is applied to the major faces and the side wall element to ensure adequate adhesion to retain the folded shipping pack thus formed in its storage or transport configuration.

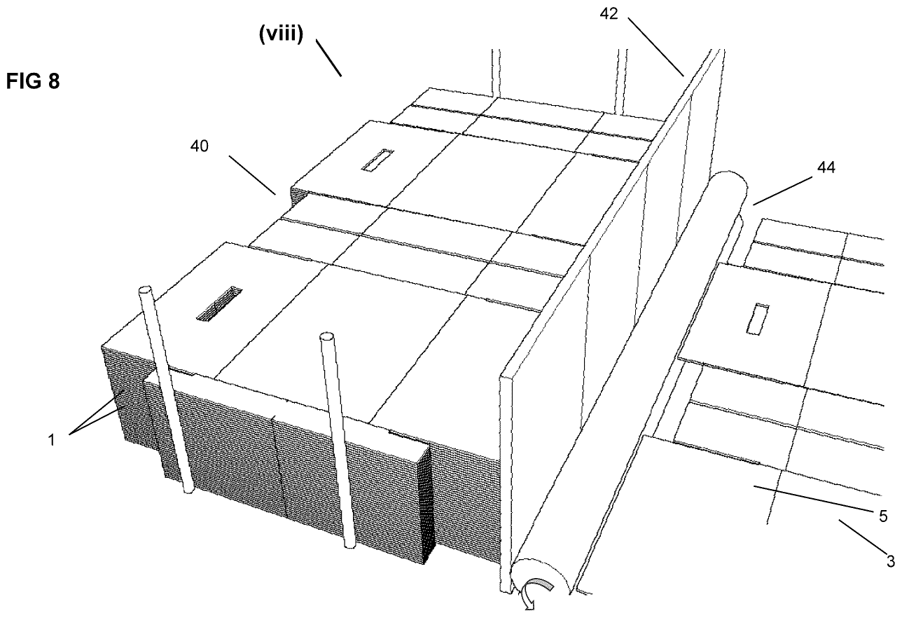

Each stage of the method is described with respect to stations (viii) to (xiv) of the apparatus, illustrated in FIGS. 8 to 14, respectively.

At the first station (viii) cardboard blank stock 1 is loaded into a bottom feed magazine 40 where it is gripped by a vacuum belt (not shown). The second station comprises a gate which, when lifted, allows a vacuum gripped blank to be fed to a pair of nip rollers which present the container blank one for processing. The third station illustrated in the FIG. 10, comprises a glue application station where a glue gun (or series thereof) applies a predetermined pattern of adhesive to the inner surface of the front wall 3, ideally in the form of glue lines 3g, and optionally also glue lines 2g to the rear wall 2. The additional glue lines 2g on the rear wall may be applied to the inner surface thereof as it is brought past the adhesive application station or separately. This alternative method is in contrast to the exemplifying method illustrated in FIGS. 3 to 5.

Additionally, at the glue application station, a handle 48 is glued to the inner surface of a lid section which features an aperture 49 adapted to align with a corresponding aperture on the other one of the lid sections, so that when the lid is formed, a handle may be pulled through the apertures for convenient lifting of a filled shipping pack.

An additional glue line 17g may be applied to the free side wall element 17 for subsequent adherence to the closing tab 20.

In FIG. 11, at the fourth station (xi), a second magazine 50 contains a stock of folded bags 30 from which a single bag is drawn, in a manner similar to the container blank feed, to be placed under process control registration in alignment with the periphery of the front wall 3 so that the peripheral end of the bag (the respective fold lines 31b, 32b of faces 31,32) aligns with the base fold line 7a and so that the open mouth thereof does not extend beyond the peripheral edge of the lid section 5.

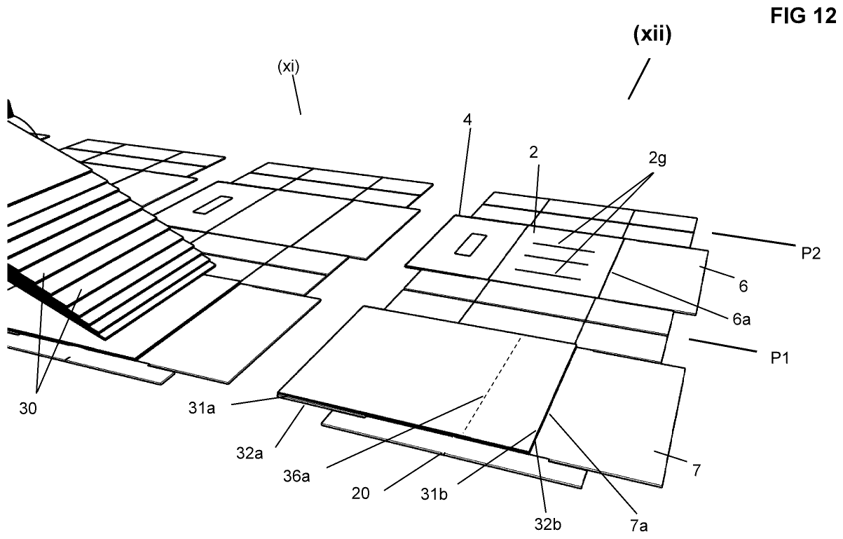

A vacuum plate or similar bag conveyance means carries and places the bag 30 in position and optionally applies a glue activating pressure thereto to ensure bonding of the adhesive in the glue lines 3g to the rear face 32 of the bag 30. Ideally, however, at the 5th station (xii), illustrated in FIG. 12 which shows the precise positioning of the interior bag 30 with respect to the container blank 1, pressure is applied, for example by pinch rollers or a contact plate, to ensure adherence of the glue in glue lines 3g to the rear surface 32 of the bag. Where cold-seal adhesive is used, the pressure applied to the front surface 31 of the bag activates the adhesive in the glue lines 3g.

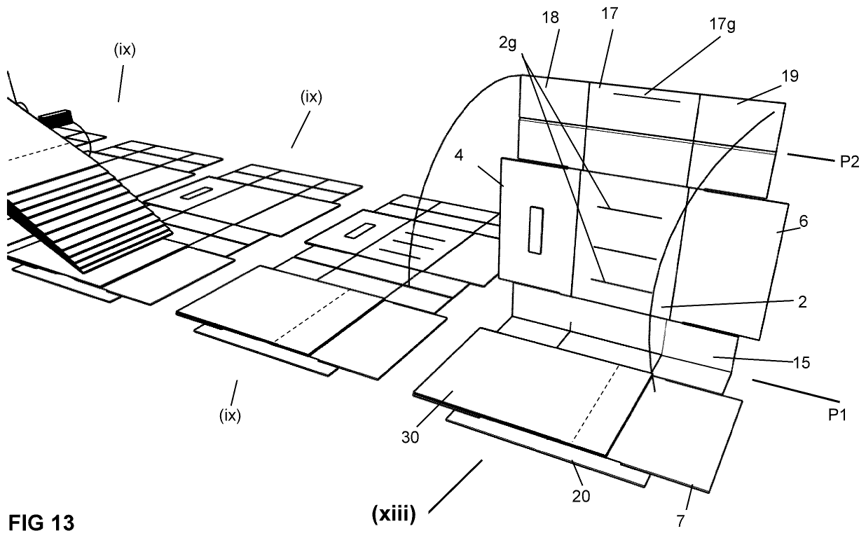

FIG. 13 illustrates the actions conducted at a sixth station (xiii) where the container blank 1 is folded around its first primary fold line P1 to align the rear face 2 with the exposed front face 31 of the interior bag. Glue lines 2g applied to the rear face 2 of the blank 1 engage and adhere (with additional applied pressure where required) to the front face of said interior bag 30. The free end wall element 17 (together with its lid and base elements 18, 19) is folded over the second primary fold line P2 so that the end closing tab is adhered thereto either by a glue line 17g applied to the free end wall element 17, as referenced above, and/or a glue line 20g applied to the outer surface of said tab 20. Pressure may again be applied to the outer surface of the folded shipping packed thus formed to ensure the required adhesion of the front and rear faces 31, 32 of the interior bag 30 to the major interior surfaces 2, 3 of the container blank 1.

FIG. 14 illustrates a seventh station (xiv) where successive folded shipping packs are stacked. Stacks may be fed to a magazine for immediate use or maybe bundled for storage or transportation.

The first apparatus of the invention implements the method of forming a folded shipping pack from a container blank and interior bag which may then be conveyed individually to a further erecting, filling and sealing apparatus or stacked for storage or for transportation to a sales outlet or distribution facility.

To form the base of the shipping pack, the base elements 15, 19 are deflected inwardly about their respective fold lines 15a, 19a and each of the base forming sections 6, 7 are subsequently folded about their respective fold lines 6a, 7a to align each of the base components. Where the free edges of the base forming sections 6, 7 meet, they are secured by the application of a strip of adhesive tape. The previously folded shipping pack is now in an open-mouthed configuration to receive articles or loose-fill produce, as required.

In an unillustrated embodiment, there is provided an apparatus for erecting, filling and sealing an open-mouthed shipping pack formed from a folded shipping pack as herein defined of the type having an interior folded open-mouthed bag 30. Ideally, the apparatus includes a means for erecting the folded shipping packed into an open-mouthed configuration by applying side wall pressure on or adjacent the primary fold lines P1, P2 thereby deploying the interior bag 30 into a corresponding open-mouthed configuration. The base sections 6, 7 of front and rear walls 2, 3 and base elements 15, 19 of respective side walls 11, 12; 16, 17 are brought together and secured to form a shipping pack base adjacent and supporting the base 36 of the interior bag 30.

The apparatus further comprises a filling station having means for placing one or more articles or for pouring produce into the open-mouthed bag within the erected shipping pack and a means for subsequently closing the open mouth of the interior bag. Where the interior bag is provided with additional fold lines formed around the open mouth thereof, these may be utilised to form a sealable closed-mouth configuration.

In one arrangement, the interior bag has cohesive portions to which adhesive has been applied adjacent the open mouth thereof and the apparatus includes means for bringing the portions together under applied pressure so that the adhesive bonds to seal the bag.

Finally, the apparatus is provided with means for bringing together and securing lid sections 4, 5 of the front and rear walls 2, 3 and lid elements 14, 18 of said side walls 11, 12; 16, 17 to form a shipping pack lid over the closed or sealed mouth of the interior bag and the lid thus formed is sealed, whereafter a conveyor means forwards the closed shipping pack towards dispatch or storage.

Optionally, the apparatus includes a dispenser for applying water activated adhesive tape to the open mouth of the interior bag and to the lid sections.

It will of course be understood that the invention is not limited to the specific details described herein, which are given by way of example only, and that various modifications and alterations are possible within the scope of the appended claims.

1.-3. (canceled)

4. A shipping pack comprising:
a container blank, so sized and shaped as to form a folded erectable shipping pack, the blank having front and rear walls to which there are attached, along respective fold lines, side wall sections each being foldable so that said front and rear walls are held in juxtaposed alignment to define a folded configuration; and
a foldable open-mouthed bag defining a sealed base and a sealable open mouth and having front and rear faces which are operably adhered between the front and rear walls of the blank,
wherein, as the container blank is erected from said folded configuration, the folded interior bag is deployed to an open-mouthed configuration to assume substantially the inner volume of said erected blank so as to provide an open-mouthed shipping pack having an open-mouthed interior bag to be filled and subsequently sealed for dispatch.

5. A shipping pack according to claim 4, in which the container blank has a first primary fold line, about which the front wall is folded to align with and adhere to a front face of the interior bag, and a second primary fold line, about which a side wall section is folded to align with an end closing tab which is adhered thereto to assume said folded storage or transport configuration to present a flat stackable folded shipping pack with interior bag.

6. A shipping pack according to claim 4, in which the interior bag is provided in a folded configuration where the side walls and base thereof are folded along respective centrally disposed longitudinal fold lines so as to present only the rear and front faces thereof as major surfaces to be adhered to the inner surfaces of the rear and front walls respectively of the container blank.

7. A shipping pack according to claim 4, in which a coating is applied to at least the inner surface of the interior bag.

8. A shipping pack according to claim 4, in which additional fold lines are formed around the open mouth of the interior bag so as to direct a user to form manually a sealable closed-mouth configuration.

9. A shipping pack according to claim 4, in which the interior bag has cohesive portions to which adhesive is applied adjacent the open mouth thereof, the portions being brought together so that the adhesive bonds to seal the bag.

10. A shipping pack according to claim 9, in which the cohesive portions are spray coated with a cold-seal adhesive.

11. A shipping pack according to claim 4, in which the open mouth of the interior bag is sealed using water activated adhesive tape.

12. A shipping pack according to claim 4, in which the pack comprises:
a container blank having a series of six segments, each defining a wall section to which there is attached, along respective fold lines, a base element and a lid element, the segments being joined to at least one other segment by a side wall fold line; and
an interior bag, having wall segments corresponding to each of those of the blank, to which there is attached, along respective fold lines, a base element which in a storage or transport configuration is folded along a central longitudinal fold line and in its erected configuration forms a flat base region perpendicular to each of the bag segments;
wherein the interior bag, in its erected configuration is deployed to conform to the interior volume of the erected container blank to form an open-mouthed shipping pack for receipt of articles or produce to be sealed therein for dispatch.

13. A shipping pack according to claim 4, in which the interior bag is so sized and shaped as to fit within the peripheral profile of the container blank, thereby minimising snagging and facilitating increased throughput.

14. A method of forming a shipping pack of the type claimed in claim 4 from a container blank having front and rear walls to which there is attached a deployable interior open-mouthed bag adapted to deploy from a folded configuration to align with and conform to the inner volume of an erected pack formed from said blank, the method comprising:
forming a folded shipping pack by adhering a major face of a folded bag onto the interior surface of one of said front or rear walls of the container blank and folding, into alignment with the adhered bag and selected wall, the other of said front and rear walls around a primary fold line therebetween; and
folding a free wall edge of the container blank around a second primary fold line and adhering an end closing tab thereto so as to secure the shipping pack in a storage or transport configuration with said bag secured therein.

15. A method of forming a shipping pack according to claim 14, the method further comprising:
erecting the folded shipping packed into an open-mouthed configuration by applying side wall pressure thereby deploying the interior bag into a corresponding open-mouthed configuration;
bringing together and securing base sections of front and rear walls and base elements of said side walls to form a shipping pack base adjacent and supporting the base of the interior bag;
placing one or more articles or produce into the open-mouthed bag within the erected shipping pack;
closing the open mouth of the interior bag;
bringing together and securing lid sections of front and rear walls and lid elements of said side walls to form a shipping pack lid over the sealed mouth of the interior bag;
sealing the lid; and
conveying the closed shipping pack for dispatch or storage.

16. A method of forming a shipping pack according to claim 15, in which additional fold lines are formed around the open mouth of the interior bag so as to facilitate a sealable closed-mouth configuration.

17. A method of forming a shipping pack according to claim 15, in which the interior bag has cohesive portions to which adhesive is applied adjacent the open mouth thereof, the portions being brought together so that the adhesive bonds to seal the bag.

18. A method of forming a shipping pack according to claim 14, in which the open mouth of the interior bag is closed and the lid sections are secured using water activated adhesive tape.

19. An apparatus for forming a shipping pack of the type claimed in claim 4 from a container blank having attached therein a deployable interior open-mouthed bag adapted to deploy from a folded configuration to align with and conform to the inner volume of an erected pack formed from said blank, the apparatus comprising:
a magazine from which a container blank is fed;
an adhesive application station;
a magazine from which a folded bag is fed onto a selected inner face of a first major surface of the container blank;
a conveyor means;
a folding station where the blank is folded around a primary fold line to bring the inner surface of a second major surface into alignment with said first surface between which the folded bag is disposed and to bring an end closing tab adjacent a second primary fold line;
a folding means adapted to fold a free side wall element around said second primary fold line to overlie the closing tab; and
a forming station where pressure is applied to the major faces and the side wall element to ensure adequate adhesion to retain the folded shipping pack thus formed in its storage or transport configuration.

20. An apparatus for erecting, filling and sealing an open-mouthed shipping pack formed from a folded shipping pack of the type claimed in claim 4, the apparatus including:
means for erecting the folded shipping packed into an open-mouthed configuration by applying side wall pressure thereby deploying the interior bag into a corresponding open-mouthed configuration;
means for bringing together and securing base sections of front and rear walls and base elements of said side walls to form a shipping pack base adjacent and supporting the base of the interior bag;
a filling station having means for placing one or more articles or for pouring produce into the open-mouthed bag within the erected shipping pack;
means for closing the open mouth of the interior bag;
means for bringing together and securing lid sections of front and rear walls and lid elements of said side walls to form a shipping pack lid over the sealed mouth of the interior bag;
sealing means for closing the lid; and
conveyor means for conveying the closed shipping pack for dispatch or storage.

21. An apparatus for erecting, filling and sealing an open-mouthed shipping pack according to claim 20, in which additional fold lines are formed around the open mouth of the interior bag so as to facilitate closing the open mouth of the interior bag to form a sealable closed-mouth configuration.

22. An apparatus for erecting, filling and sealing an open-mouthed shipping pack according to claim 20, in which the interior bag has cohesive portions to which adhesive is applied adjacent the open mouth thereof, the apparatus including means for bringing the portions together under applied pressure so that the adhesive bonds to seal the bag.

23. An apparatus for erecting, filling and sealing an open-mouthed shipping pack according to claim 20, in which the apparatus includes a dispenser for applying water activated adhesive tape to the open mouth of the interior bag and to the lid sections.

24. A shipping pack according to claim 4, in which in an erected, open-mouthed configuration, base-forming elements of the blank are folded around their respective fold lines to abut and support the sealed base of the interior bag, so that the pack may be filled with produce for shipping and storage.
